(19) United States
(12) Patent Application Publication
(10) Pub. No.: US 2006/0032329 A1
(43) Pub. Date: Feb. 16, 2006

(54) Novel structures and method of preparation

(75) Inventors: Israel Rubinstein, Rehovot (IL); Alexander Vaskevich, Rehovot (IL); Michal Lahav, Rehovot (IL); Tali Sehayek, Herzliya (IL)

Correspondence Address: BROWDY AND NEIMARK, P.L.L.C.;624 NINTH STREET, NW, SUITE 300, WASHINGTON, DC, 20001-5303, US

(73) Assignee: Yeda Research and Development Co. Ltd, Rehovot (IL)

(21) Appl. No.: 10/542,789

(22) PCT Filed: Jan. 22, 2004
(86) PCT No.: PCT/IL04/00061

§ 371 Date: Jul. 20, 2005

Related U.S. Application Data
(60) Provisional application No. 60/441,767, filed on Jan. 23, 2003.

(51) Int. Cl. B05D 1/12; B05D 7/22

(52) U.S. Cl. 75/255; 427/180; 427/230; 75/370

(57) ABSTRACT

The present invention provides a new method for the synthesis of a novel kind of high-surface-area structures. A substrate is provided having pores or channels functionalized with an agent capable of binding nanoparticles, said pores or channels having a cross-sectional size of from about several nanometers to about 100 microns. A colloid solution comprising stabilized nanoparticles and a solvent is passed through said substrate, so as to bind and form more than one layer of nanoparticles in the pores or channels, where the bound nanoparticles spontaneously coalesce to form a coherent material having a substantially hollow structure and being composed of nanoparticles, where said structure follows the shape of said pores or channels in the substrate. The structures properties can be modified by deposition of another material, to form structures coated by the other material on their surface. The structures (with or without modification) can be separated from the porous substrate to obtain a material having a desired structure, for example a tubular structure.

### FIELD OF THE INVENTION

The present invention relates to nano- and microstructures and a method of preparing such structures.

### BACKGROUND OF THE INVENTION

In recent years there has been considerable interest in the synthesis of structured materials and control of their shape and geometry on different length scales, from molecular systems to macroscopic objects. Special attention has been given to materials structured on the nanometer scale, as this represents a step down in scale from present technology. Two prominent components of such systems are nanoparticles and nanotubes.

Nanoparticles, particularly attractive building blocks for nanomaterial architectures, can be prepared from a variety of materials including metals, semiconductors, polymers, etc. Their dimensions are typically from several to hundred nanometers, providing unique flexibility in length scale and properties in the synthesis of composite nanomaterials. Examples include controlled aggregation in solution, as well as binding to templates such as macromolecules and to solid substrates of planar or curved geometries. Using such methods, a variety of self-sustained structures, including hollow spheres, rods, and chainlike multiparticle assemblies, have been obtained.

Nanotubes are nanometer scale tubes, which consist of one or more concentric cylindrical shells made of a certain material. Carbon nanotubes, as well as other types, including metallic nanotubes, have been prepared in the last decade (M. Nishizawa, V. P. Menon, C. R. Martin, Science, 268, 700-702 (1995)).

The nanotubes can be produced from metals (e.g. Ag), or other inorganic (e.g. TiO₂, HfS₂, V₇O₁₆, CdSe, MoS₂) and polymeric (e.g. polyaniline, polyacrylonitrile) materials. The various types of nanotubes are synthesized by various methods, including inter alia template synthesis in nanoporous alumina membranes or track-etched polymeric membranes. The techniques of template synthesis of nanotubes include electrochemical deposition, electroless (chemical) deposition, polymerization, sol-gel deposition, or chemical vapor (CVD) deposition in the nanoporous membranes. Immobilization of a layer of isolated nanoparticles on the pore walls of alumina membranes functionalized with organic linker molecules is disclosed in the following publication:

T. Hanaoka, H. P. Kormann, M. Kroll, T. Sawitowski, G. Schmid, Eur. J. Inorg. Chem., 807-812 (1998).

### SUMMARY OF INVENTION

The present invention provides a new kind of material having a structure composed of nanoparticles characterized by a high surface area. It should be understood that the term “structure” used herein signifies hollow structures of any desired geometry, which may for example be in the form of nanotubes, microtubes, channels, etc. The material of the invention is prepared by a novel method involving assembly of nanoparticles on a substrate having a defined geometry of channels or pores, accompanied by spontaneous room-temperature coalescence of the bound nanoparticles. When the substrate is a porous substrate (e.g., alumina, silicon, etc.), or consists of channels, the structures are assembled inside the pores or the channels. Under certain conditions, this process leads to formation of structures that fill part or the entire pore or channel length. Solid, self-sustained structures, e.g. nanotubes (also termed hereinafter nanoparticle nanotubes or NPNTs) are obtained by template dissolution. When the substrate contains channels, the nanostructures are deposited on the internal side of the channel walls.

In the context of the present invention, the term “coalesce” or “coalescence” are intended to describe a process where single particles unite into a whole to give a material having a coherent structure. This process may occur at various temperatures, preferably around room temperature. In addition, the term “pore” is intended to describe protruding through-holes that penetrate from one side of the substrate to the other side and “channel” is intended to describe an enclosed or partly enclosed path having at least two open extremities for letting a fluid passing through.

Thus, according to a first aspect, the present invention provides a method of preparing a material of a desired structure composed of nanoparticles, the method comprising:
(i) providing a substrate having pores or channels functionalized with an agent capable of binding nanoparticles, said pores or channels having a desired shape and a cross-sectional size from about several nanometers to about several hundreds of microns; and
(ii) passing through said substrate a colloid solution comprising nanoparticles and a solvent, so as to bind and form more than one layer of nanoparticles on the walls of the pores or channels, where the nanoparticles spontaneously coalesce to form a coherent material;

thereby obtaining a material having a substantially hollow structure that follows the shape of the pores or channels in the substrate.

The method of the invention preferably affords the preparation of a material made of metal, metal oxide, semiconductor, polymer, composite material or mixtures thereof. In the context of the invention, a composite is a coherent material composed of two or more kinds of nanoparticles. Preferred results were obtained with metals such as gold and silver, or mixtures of gold, silver and palladium. In the case of such mixtures, the resultant material was a composite material.

The nanoparticles in the colloid solution passed through the substrate are stabilized by an organic stabilizer such as citrate salt, for example tri-sodium citrate dihydrate or ammonium salt such as tetraoctyl ammonium bromide. In addition, depending on the amount and/or concentration of nanoparticle containing solution passed, thin- or thick-wall structures are formed. These structures may be highly porous and can be obtained in a free-standing tubular form by removing the substrate. In case of an alumina substrate, the substrate is removed chemically by dissolution.

In a porous substrate the pores are usually nanopores or micropores. The structures are prepared within the pores of the substrate, which serves as a template in the preparation process. The material obtained with such porous substrate has a substantially hollow structure that follows the shape of the pores or channels in the substrate. The structures may be separated from the porous substrate to obtain a self-sustained material.

The immobilization of particles on the pore or channel walls in the process of the present invention is not restricted to a single layer of nanoparticles. Continuous flow of the colloid solution through the pores or channels promotes, first the binding of the nanoparticles to the agent in the pores and channels that is capable of binding nanoparticles and secondly, additional nanoparticle binding and formation of a multilayer structure. The immobilization is assumed to involve aggregation of surface-confined nanoparticles accompanied by spontaneous coalescence (possibly during substrate drying) to yield continuous, solid material.

The substrate can be made of ceramics, polycarbonate, polymeric materials, metals, semiconductors, oxides such as glass, e.g. glass coated microwires, or any other material having a defined geometry of channels or pores and being capable of binding nanoparticles. In case of a porous substrate, the pores penetrate from one side of the substrate to the other side, and have typical pore diameter of between about 20 nm to about 100 microns. Preferably, the pore diameter is between about 20 nm to about 500 nm.

The substrate may bind nanoparticles either directly or through a surface modification reaction which assembles to the substrate functional groups capable of binding the desired nanoparticles. For example, in a preferred embodiment, the substrate is made of alumina, and the nanopores are functionalized with bi-functional molecules having one group capable of binding to alumina (e.g., a silane) and another group (e.g., an amine) capable of binding nanoparticles. Examples of such bi-functional molecules are amino- or thio-functionalized alkoxysilanes, such as for example 3-aminopropyl trimethoxysilane (APTMS). In another example, where the substrate is made of a polymer material, a certain amount of a bifunctional molecule, for example APTMS, can be added to polymer precursors before polymeric substrate formation, for example to poly-dimethylsiloxane (PDMS) precursors. The resulting polymeric substrate is capable of binding nanoparticles.

According to another aspect, the present invention provides a method of preparing a metal-based material composed of nanoparticles and having a substantially hollow structure, the method comprising:
(a) providing a substrate having pores or channels functionalized with an agent capable of binding metal nanoparticles, said pores or channels having a diameter of several nanometers to several hundreds of microns, preferably from about 20 nm to about 100 microns;
(b) passing through said substrate a colloid solution comprising nanoparticles of one or more metal source and a solvent, so as to bind and form more than one layer of nanoparticles on the walls of the pores or channels, where the nanoparticles spontaneously coalesce to form coherent metallic-based structures; and
(c) optionally, in the case of a porous substrate, separating the metal-based structures from the porous substrate to obtain a conductive metal-based material.

When the method of the invention is carried out with a porous substrate having nanopores or micropores, the resulting material obtained after the separation from the substrate has a substantially nano- or microtubular structure.

In a preferred embodiment, the present invention provides a method of preparing gold nanotubes, the method comprising:
(a1) providing a substrate having nanopores functionalized with an agent capable of binding gold nanoparticles, said nanopores penetrating from one side of the substrate to the other side and having a diameter of about 20 nm to about 500 nm;
(a2) passing through said substrate a colloid solution comprising stabilized gold nanoparticles and water, so as to bind and form in the nanopores more than one layer of gold nanoparticles, where the nanoparticles spontaneously coalesce to form coherent gold nanotubes; and optionally
(a3) separating the gold nanotubes from the substrate.

In a similar manner there were prepared by the method of the invention silver nanotubes, as well as composites of gold/silver nanotubes and gold/palladium nanotubes. These nanotubes are about 200 nm in diameter and are composed of continuous, multi-layered nanoparticle arrays consisting of nanoparticles of about 10-20 nm diameter.

The nanotubes of the invention are mechanically stable, electrically conducting and display a distinct surface plasmon optical absorption. These nanotubes combine nanotube geometry with nanoparticle properties (e.g., high surface-to-volume ratio; surface plasmon absorption).

Modification of the nanotube properties can be achieved by depositing on their surface another material, forming hybrid nanotube-based material. In the case of electrically conducting nanoparticle nanotubes, electrochemical modifications are possible.

Thus, the method of the invention may comprise another step after step (b) or (a2) and before the optional step (c) or (a3), according to which a deposition step with an additional material is carried out, thereby producing a coating on the surface of said structures, e.g. nanotubes, so as to form hybrid structures, e.g. nanotubes, with modified chemical structural and mechanical properties. A specific example of the coating material is copper. A thin copper layer may be deposited either by an electroless method or by electrodeposition.

There is thus provided according to yet another aspect of the present invention, a catalyst or electrocatalyst comprising structures, e.g. nanotubes, that may be electrically conductive and consist of nanoparticles bound together in the form of hollow structures, e.g. nanotubes, where the nanoparticle diameter is between about 1 to about 50 nm.

The structures, e.g. nanotubes prepared by the method of the present invention may be used in various fields, for example as molecular filters for chemical and bioseparations, as the basis of highly sensitive chemical and biological sensors. Owing to the fact that the metal (generally, electrically conductive) nanotube structure of the present invention maintains the spectral properties of the metal nanoparticles, this structure can be used as electrical or optical sensor.

The possibility to form composite nanotubes, as well as the surface modification of the nanotubes by electrochemical or chemical (electroless) means, enables the synthesis of new families of nanomaterials displaying a nanotube geometry, extremely high surface area, mechanical stability, electrical conductivity, distinct optical absorption, and diverse surface chemistries. These unique properties may be particularly useful in catalysis, electrocatalysis, microfluidic systems, as well as in future device applications. The porous tubular structure of the present invention actually defines curvilinear channels.

Thus according to yet another aspect of the present invention, there is provided a filter comprising structures, e.g. nanotubes prepared by the method of the invention and consisting of nanoparticles fused together in the form of hollow nanotubes, where the nanoparticle diameter is between about 1 to about 50 nm.

According to yet another aspect of the present invention, there is provided an optical sensor comprising a structure formed by nanotubes prepared by the method of the invention and consisting of nanoparticles of about 1-50 nm diameter fused together in the form of hollow nanotubes, the structure having a predetermined absorption spectrum defined by the absorption spectrum of said nanoparticles.

The present invention according to its yet another aspects provides a method of separating a specific material from a solution containing said specific material comprising passing said solution through the nanotubes structure of the present invention.

### BRIEF DESCRIPTION OF THE DRAWINGS

In order to understand the invention and to see how it may be carried out in practice, some preferred embodiments will now be described, by way of non-limiting example only, with reference to the accompanying drawings, in which:

FIG. 1 schematically exemplifies the preparation of metal nanoparticle nanotubes (NPNTs), utilizing passage of a solution of metal nanoparticles through a silanized alumina membrane, followed by membrane dissolution.

FIGS. 2A and 2B show E-SEM images of cross-sections of silanized nanoporous alumina membranes after passing an Au nanoparticle solution (A), followed by Cu electrodeposition at −0.6 V for 1000 sec (B).

FIGS. 3A to 3C show the E-SEM images of nanoparticle nanotubes obtained after alumina membrane dissolution in 1.0 M NaOH at three different magnifications A-C, wherein (C) is a magnified image of the area marked in (B), showing the arrangement of individual nanoparticles.

FIGS. 4A to 4C show the TEM images of a nanoparticle nanotube obtained after alumina membrane drying and dissolution in 1.0 M NaOH, at different magnifications A-C, wherein (C) is a magnified image of the area marked in (B), showing the tubular structure.

FIG. 5 shows the transmission UV-vis spectra of Au nanoparticle nanotubes in solution (A) and on a glass slide (B), and in the inset, an E-SEM image of Au NPNTs on the glass slide.

FIGS. 6A and 6B show E-SEM images showing top view (A) and cross-section (B) of nanotubes after Cu electrodeposition on the surface of Au NPNTs, followed by alumina membrane dissolution, wherein the electrodeposition was carried out at −0.8 V for 100 sec (A) and 60 sec (B) in an aqueous solution containing 0.3 M CuSO₄ and 0.1 M H₂SO₄.

FIGS. 7A to 7D show the E-SEM images of Ag NPNTs obtained after passing the Ag nanoparticles solution followed by membrane drying and dissolution in 1.0 M NaOH at different magnifications A-C, wherein B and C show, respectively, the arrangement of individual Ag nanoparticles and the tubular structure of Ag NPNTs.

FIGS. 8A to 8C show (A and B) the E-SEM images and the EDS results (C) of Au/Ag composite NPNTs obtained after NPNT synthesis followed by drying and alumina membrane dissolution in 1.0 M NaOH.

FIGS. 9A to 9C show (A and B) the HR-SEM images and (C) EDS results of Au/Pd composite NPNTs obtained after NPNT synthesis followed by drying and alumina membrane dissolution in 1.0 M NaOH.

### DETAILED DESCRIPTION OF THE INVENTION

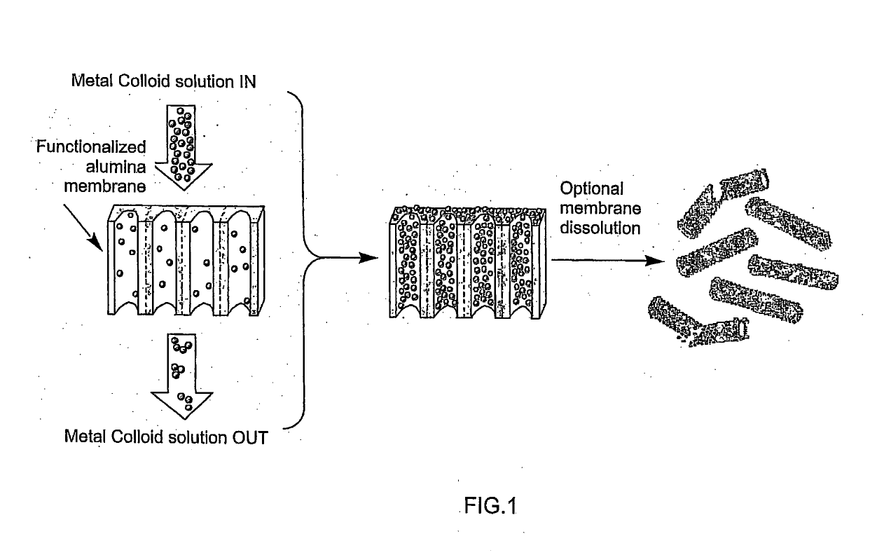

Referring to FIG. 1, there is schematically illustrated a process of preparation of metal, e.g. Au, nanoparticle nanotubes (NPNTs). Alumina membranes (ca. 200 nm pore diameter) were preteated with 3-aminopropyl trimethoxysilane (APMS) according to a literature procedure [C. A. Goss, D. H. Charych, M. Majda, Anal. Chem. 63, 85-88 (1991]. The silyl groups react with the hydroxyl groups on the alumina surface, leaving the amine groups available for binding the desired metal nanoparticles. In case of gold nanoparticles, Au colloid solution (14±2 nm diameter), citrate stabilized [J. Turkevich, P. C. Stevenson, J. Hiller, Discuss. Faraday Soc. 11 (1951] was then passed through the modified membrane pores by vacuum suction. The nanoparticles interact with the amine groups of the APMS, thus getting immobilized upon forming Au nanoparticle layers on the walls.

The immobilization process is accompanied by spontaneous room-temperature coalescence, to yield continuous multi-layered nanoparticle nanotubes (NPNTs) in the alumina pores. Without being bound to theory, a possible mechanism for the spontaneous sintering is partial stripping of the citrate stabilizing shells of metal nanoparticles.

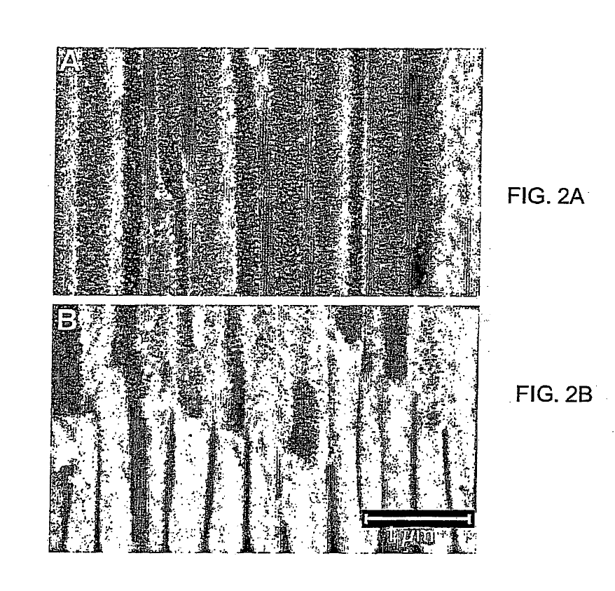

The Au nanoparticles bound in the membrane pores are visualized by cross-section E-SEM imaging of the membrane following colloid binding, as seen in FIG. 2(A).

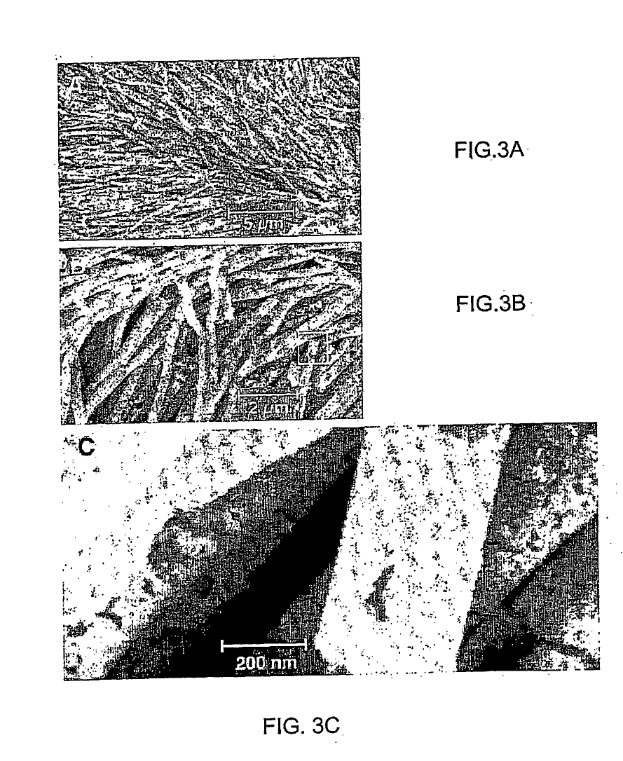

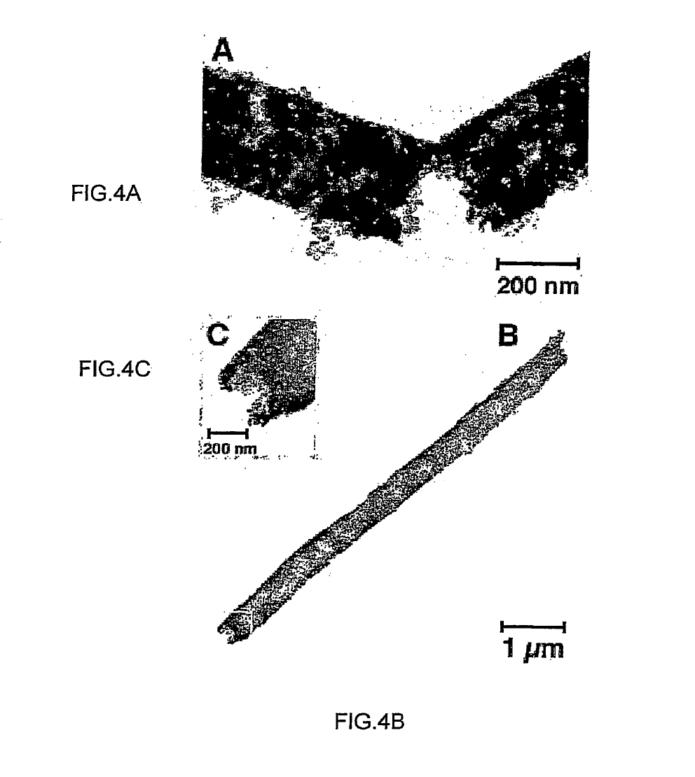

Dissolution of the dried alumina membrane in 1.0 M NaOH followed by removal of the solution leads to the release of solid, self-sustained Au NPNTs. FIGS. 3A-C and 4A-C show E-SEM and TEM images, respectively, of the free-standing nanotubes, presented at different magnifications. FIGS. 3(C) and 4(C) are magnified images of the areas marked in FIGS. 3(B) and 4(B), respectively, showing the arrangement of individual nanoparticles The tubes are composed of continuous, mostly multi-layered nanoparticle arrays. Some tubes are partly bent after membrane dissolution and drying, as may be seen in FIGS. 3(A) and 3(B). In some cases, defects and cracks are seen along the tubes, but the geometrical shape of the NPNTs is preserved. Electron diffraction produced a pattern characteristic of an assembly of randomly-oriented Au crystallites.

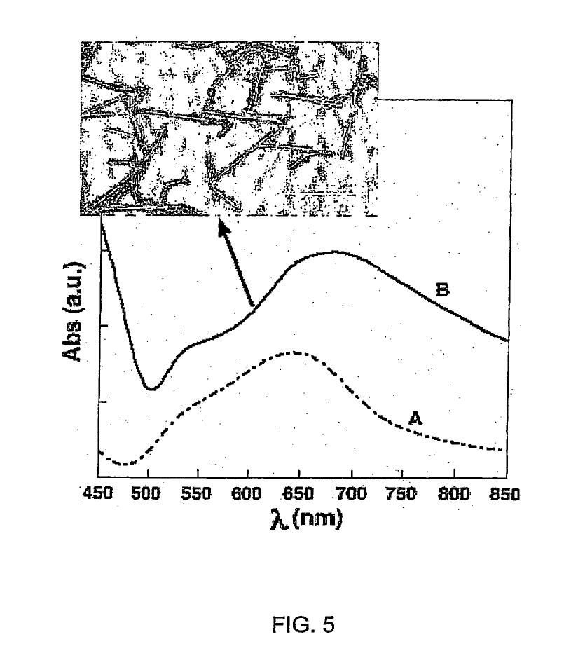

FIG. 5 shows transmission UV-vis absorbance spectroscopy of the NPNTs carried out in solution (graph A) and with a sample evaporated on a glass slide (graph B). A NPNT solution was prepared by dissolving the alumina membrane in 1.0 M NaOH, followed by removal of the solution and re-dispersion of the NPNTs in water. The dry sample was prepared by applying a drop of the NPNT solution on a cleaned microscope cover slide followed by evaporation of the solution. Two absorbance features of different intensities are seen in both spectra. The weaker absorbance appears at approximately the same wavelength (ca. 530 nm) in both spectra, and can be attributed to a small amount of free nanoparticles. The more intense absorbance appears at longer wavelengths and can be attributed to nanoparticle assemblies. The latter is shifted more to the red in the dry sample (ca. 675 nm vs. 645 nm), which can be due to the different media, different orientations of the tubes in the solution and on the slide, and possibly a structural change (additional aggregation) upon nanotube drying. The dry sample was also imaged by E-SEM (FIG. 5, inset) to confirm the presence of Au NPNTs on the glass slide.

The NPNTs are electrically conductive, a fact that can be used to modify their chemical, structural and mechanical properties using electrodeposition. In the present case, a small amount of copper was electrodeposited on the inner surface of the NPNTs following Au colloid immobilization and prior to membrane dissolution. The membrane was mounted in a special holder, leaving the ‘outlet’ side (bottom side of the membrane in FIG. 1, middle) in contact with a Cu²⁺ solution. Electrical connection (cathode) was established by contacting the ‘inlet’ side of the alumina membrane, covered with bound Au nanoparticles. A cross-section E-SEM image of a membrane modified by Cu electrodeposition (prior to membrane dissolution) is seen in FIG. 2(B). Cu covered Au NPNTs are seen in the region of the membrane that faced the Cu²⁺ solution.

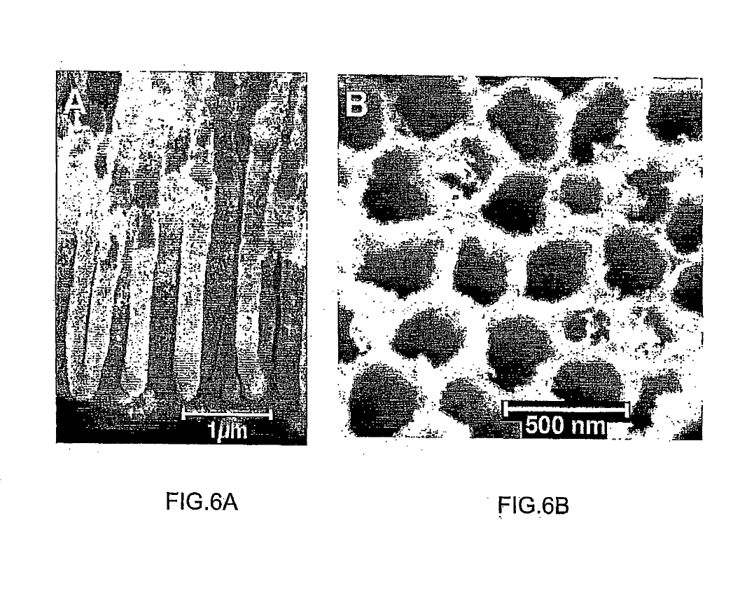

The Cu-covered hybrid NPNTs are considerably more robust than the pristine Au NPNTs. This is seen in FIGS. 6(A) and 6(B), showing, respectively, E-SEM side view and top view of Cu-covered Au NPNTs after membrane dissolution. A well-ordered assembly of continuous, rigid, hollow nanotubes is observed, evidently formed by collapse of the nanotubes toward each other during membrane dissolution and subsequent drying (see top view). The basic nanoparticulate structure is maintained, as seen in both images. Careful inspection suggests that most of the defects are ‘repaired’ by the deposited Cu.

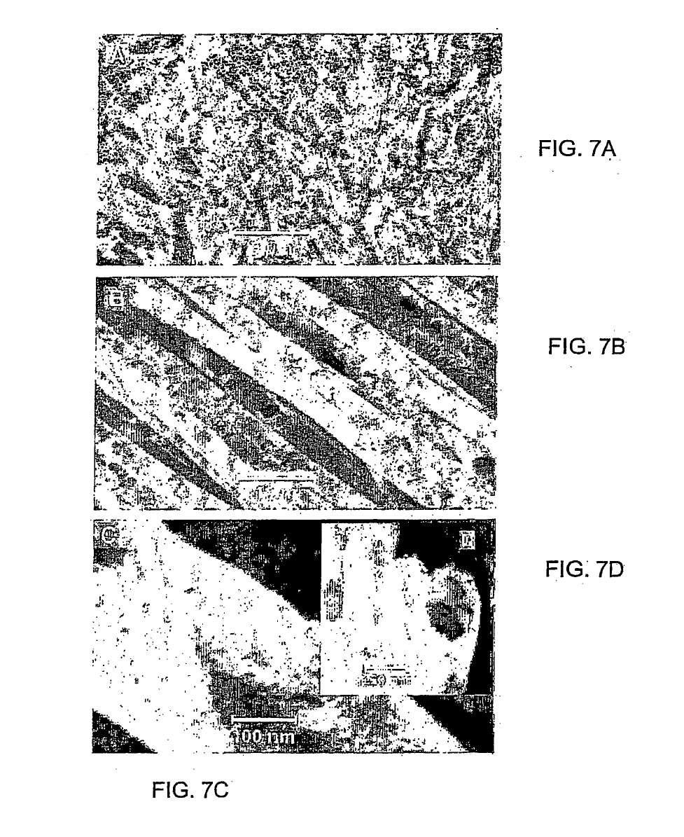

The E-SEM images of Ag NPNTs, obtained after passing the Ag nanoparticles solution and followed by membrane drying and dissolution in 1.0 M NaOH is shown in FIG. 7, at different magnifications A-C. Magnification B shows the arrangement of individual Ag nanoparticles and C shows the tubular structure of Ag NPNTs.

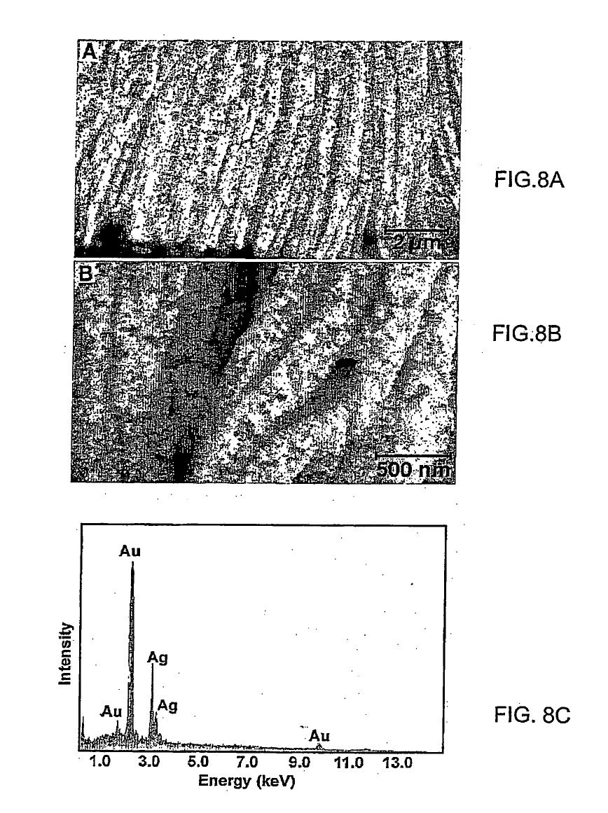

The E-SEM images of Au/Ag composite NPNTs obtained after NPNT synthesis followed by drying and alumina membrane dissolution in 1.0 M NaOH are shown in FIG. 8, at two magnifications A and B. The energy dispersive spectroscopy (EDS) results in FIG. 8C shows the formation of a composite with a ratio of Ag to Au nanoparticles similar to the 1:1 ratio in the feeding solution.

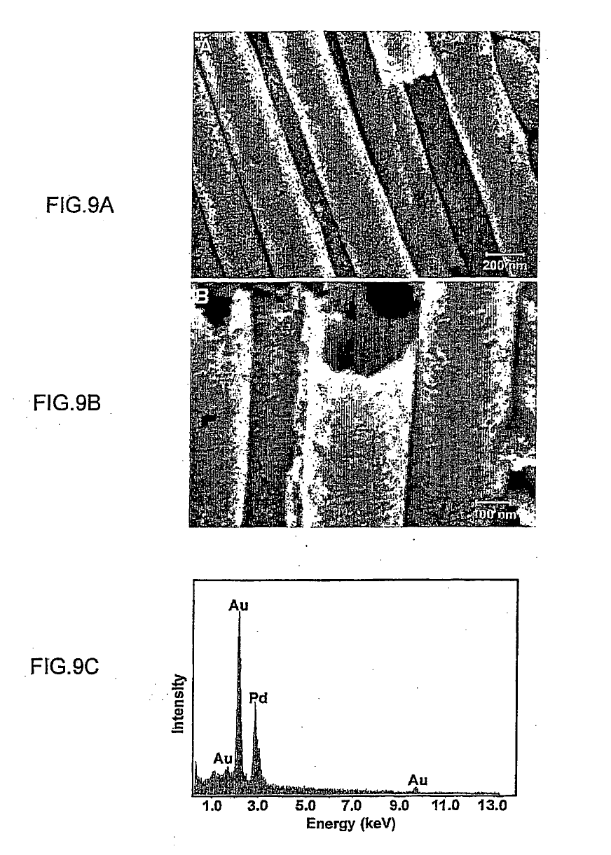

The HR-SEM images at magnifications A and B and EDS results (C) of Au/Pd composite NPNTs obtained after NPNT synthesis followed by drying and alumina membrane dissolution in 1.0 M NaOH are shown in FIG. 9. The EDS results show formation of a composite with a ratio of Pd to Au nanoparticles similar to the 1:1 ratio in the feeding solution.

The metal nanotubes prepared by the method of the present invention may be used as molecular filters for chemical and bioseparations, as the basis of highly sensitive chemical and biological sensors. The preparation of composite materials according to the invention as well as surface modification of the nanotubes by electrochemical or chemical (electroless) means, enables the synthesis of new families of nanomaterials displaying a nanotube geometry, high surface area, mechanical stability, electrical conductivity, distinct optical absorption, and diverse surface chemistries. These unique properties of the nanotubes of the present invention may be particularly useful in catalysis and electrocatalysis as well as in future device applications, for example utilizing a material supply through the nanotubes with highly developed surface or coating the inner walls of microfluidic systems. The porous substantially tubular configuration of the nanotubes of the present invention, enables its use as curvilinear channels.

### EXAMPLES

Chemicals: Sodium tetrachloroaurate (NaAuCl₄.2H₂O) (Fluka), HAuCl₄ (prepared according to a known procedure—Block, B.P. Inorganic Syntheses, Mc Graw-Hill, N.Y., 1953, 4, 14-17), AgNO₃ (Fluka), ferrous sulphate (FeSO₄.7H₂O) (BDH), potassium hexachloropalladat (IV) (Aldrich), PdCl₂ Merck), tri-sodium citrate dihydrate (Merck), CuSO₄.5H₂O Merck), NaOH Merck), 3-aminopropyl trimethoxysilane (Aldrich), 2-propanol (Biolab), H₂SO₄ (95-98%, Palacid), H₂O₂ 30% (Frutarom), were used as received. Alumina membranes (0.2 μm, Anodisc, Whatman) were sonicated in 2-propoanol prior to use. Water was triply distilled. Household nitrogen (>99%, from liquid nitrogen) was used for drying the samples. All glassware and teflonware were treated with Piranha solution (boiling H₂SO₄:H₂O₂, 2:1 by volume), followed by rinsing with deionized water and triply distilled water.

Au nanoparticle preparation: 14±2 nm Au nanoparticles were synthesized by addition of tri-sodium citrate dihydrate (160 mg) to a vigorously stirred refluxing solution of sodium tetrachloroaurate (70 mg) or HAuCl₄ (67 mg) in 100 ml water. The mixture was then stirred under reflux for additional 15 min before cooling to room temperature.

Ag nanoparticle preparation: Aqueous ferrous sulfate (60 mg /20 ml), was heated, cooled and then filtered through a 0.45 μm membrane filter. A tri-sodium citrate solution (112 mg/28 ml) was similarly filtered and then mixed with the ferrous sulfate solution. AgNO₃ (20 mg/20 ml) was passed through a 0.1 μm membrane filter and was then added to the above vigorously stirred mixture, to form Ag nanoparticles (9±2 nm). (Siiman et al., J. Phys. Chem. 87, 1014-1023 (1983)).

Pd nanoparticle preparation: 14±2 nm Pd nanoparticles were synthesized by addition of tri-sodium citrate dihydrate (535 mg) to a vigorously stirred refluxing solution of potassium hexachloropalladate (70 mg) in 100 ml water. The mixture was then stirred under reflux for additional 4 h before cooling to room temperature. (Dokoutchaev et al., Chem. Mater., 11, 2389-2399 (1999)).

Mixed NP solutions: Au/Ag and Au/Pd mixed NP solutions were obtained by mixing the previously prepared single-metal NP solutions (50:50 atomic %).

Alumina membrane silanization: A mixture of 1.9 ml 3-aminopropyl trimethoxysilane (APMS), 1.4 ml water and 100 ml 2-propanol was brought to reflux. Alumina membranes, previously sonicated in 2-propanol for 20 min and dried under a stream of nitrogen, were immersed in the refluxing mixture for 10 min, then rinsed with 2-propanol, dried under a nitrogen stream and cured in an oven at 100-107° C. for 8 min. The procedure was carried out 3 times.

Nanoparticle nanotube (NPNT) preparation: 18 ml of Au or Au/Pd NP solution, 12 ml of Ag NP solution, or 15 ml of Au/Ag NP solution were passed by vacuum suction through the silanized alumina membrane using the following protocol: (i) Passing 10 ml of the NP solution through the membrane. (ii) Sonicating the membrane for 4 min. (iii) Passing a few ml of triply distilled water through the membrane. (iv) Passing another 8 ml of Au or Au/Pd NP solution, 2 ml of Ag NP solution, or 5 ml of Au/Ag NP solution. (v) Passing distilled water through the membrane (an indication that the membrane is not blocked). The membranes were then dried under a stream of nitrogen. In order to achieve self-sustained NPNTs the alumina membrane was dissolved using 1.0 M NaOH for 2.5 h followed by washing with triply distilled water.

Samples preparation for UV-vis spectroscopy: A NPNT solution was prepared by dissolving the alumina membrane in a quiescent 1.0 M NaOH solution. Following membrane disappearance the solution was removed by careful suction, leaving the free nanotubes on the bottom of the beaker. The NPNTs were then re-dispersed in pure water. Spectra of the nanotubes on a glass slide were taken by placing a drop of the NPNT solution on a cleaned glass slide and evaporating the solution. UV-vis spectra were obtained with a Varian CARY 50 UV/VIS/NIR spectrophotometer. A baseline correction procedure was executed prior to each measurement.

Cu electrodeposition: Cu was potentiostatically electrodeposited in the Au modified membrane pores, using EG&G PARC 263A potentiostat driven by Model 270/250 Research Electrochemical Software. The electrolyte solution was 0.3 M CuSO₄+0.1 M H₂SO₄. A standard electrochemical cell was used with a K₂SO₄-sat. Hg/Hg₂SO₄ reference electrode and a Pt counter electrode. A nanoparticle modified membrane was attached at the ‘inlet’ side (FIG. 1) to a metallic plate, serving as the cathode. The applied potential was −0.6 V or −0.8 V. The deposition time was in the range 60 to 1000 sec.

Environmental scanning electron microscope (E-SEM) imaging: E-SEM secondary electron (SE) and back-scattered electron (BS) imaging was carried out with a Philips XL30 E-SEM-FEG microscope. Samples for E-SEM examination were mounted on aluminum stubs. For cross-sectional view the membrane was broken and mounted with the broken side facing the beam. Membrane dissolution for E-SEM imaging was carried out on the stub.

Transmission electron microscope (TE) analysis: A solution of Au NPNTs (1.0 μl) (see above) was evaporated on a carbon coated TEM Cu grid (400 mesh). The grid underwent glow discharge prior to use. TEM bright-field (BF) imaging and electron diffraction (ED) were carried out on a Philips CM-120 electron microscope operating at 120 kV.

High-resolution scanning electron microscope (HRSEM) imaging: HRSEM secondary electron (SE) and back-scattered (BS) electron imaging was carried out with a LEO-supra 55 VP HRSEM.

Energy dispersive spectroscopy (EDS): EDS measurements were carried out with an E-SEM.

Those skilled in the art will readily appreciate that various modifications and changes can be applied to the examples of the invention as hereinbefore described without departing from its scope as defined in and by the appended claims.

1. A method of preparing a material of a desired structure composed of nanoparticles, the method comprising
(i) providing a substrate having pores or channels functionalized with an agent capable of binding nanoparticles, said pores or channels having a desired shape and a cross-sectional size from about several nanometers to about several hundreds of microns; and
(ii) passing through said substrate a colloid solution comprising nanoparticles and a solvent, so as to bind and form more than one layer of nanoparticles in the pores or channels, where the nanoparticles spontaneously coalesce to form a coherent material;
thereby obtaining in said pores or channels a material composed of nanoparticles, said material having a substantially hollow structure that follows the shape of said pores or channels in the substrate.

2. The method of claim 1 carried out with a substrate having pores, further comprising the step of separating the material obtained in step (ii) from the porous substrate to obtain a material having a substantially hollow structure and composed of nanoparticles.

3. The method of claim 1, wherein the cross-sectional size of said nanopores or channels is of about 20 nm to about 100 μm.

4. The method of claim 1 for the preparation of metal, metal oxide, semiconductor, polymer, or composite materials.

5. The method of claim 4, wherein said material is metal-based material.

6. The method of claim 5 for preparing a metal-based material composed of nanoparticles and having a substantially tubular structure, the method comprising:
(a) providing a substrate having pores or channels functionalized with an agent capable of binding metal nanoparticles, said pores or channels having a cross-sectional size of from several nanometers to about 100 microns;
(b) passing through said substrate a colloid solution comprising nanoparticles of one or more metal source and a solvent, so as to bind and form more than one layer of metal nanoparticles in the pores or channels, where the nanoparticles spontaneously coalesce to form coherent metallic-based material; and
(c) optionally, in the case of a porous substrate, separating the metal-based material from the porous substrate to obtain a conductive metal-based material composed of nanoparticles and having a substantially hollow structure.

7. The method of claim 1 wherein said substrate is made of a material selected from ceramics, polycarbonate, polymeric material, metal, semiconductor and oxides.

8. The method of claim 7 wherein said substrate is made of a material selected from alumina and polycarbonate.

9. The method of claim 6 wherein said substrate is made of alumina and the pores are functionalized with bi-functional molecules having one group capable of binding to alumina and another group capable of binding metal nanoparticles.

10. The method of claim 6 wherein said metal is selected from gold, silver, palladium and mixtures of such metals.

11. The method of claim 1 wherein said nanoparticles are stabilized by an organic stabilizer.

12. The method of claim 11, wherein said organic stabilizer is a citrate salt.

13. The method of claim 12, wherein said citrate is tri-sodium citrate dihydrate.

14. The method of claim 9 wherein said material is separated from the substrate by dissolution in a base solution.

15. The method of claim 9 wherein said material is separated from the substrate by dissolution in an acid solution.

16. The method of claim 1 wherein said colloid solution is passed in an amount sufficient to form coherent material.

17. The method of claim 6, wherein said material is in the form of nanotubes and comprising gold, silver or mixtures of gold or silver with palladium, where each nanotube is about 200 nm in diameter and composed of continuous, multi-layered nanoparticle arrays consisting of nanoparticles of about 10-20 nm diameter.

18. The method of claim 1, further comprising a deposition step with a metal, so as to form substantially hollow structures coated by said metal on the surface of said structures.

19. The method of claim 6, further comprising after step (b) and before the optional step (c), a deposition step with an additional metal, so as to form metal structures coated by said additional metal on the surface of said structures.

20. A method of preparing gold nanotubes, the method comprising
(a1) providing a substrate having nanopores functionalized with an agent capable of binding gold nanoparticles, said nanopores penetrating from one side of the substrate to the other side and having a diameter of about 20 nm to about 500 nm;
(a2) passing through said substrate a colloid solution comprising stabilized gold nanoparticles and water, so as to bind and form in the nanopores more than one layer of gold nanoparticles, where the nanoparticles spontaneously coalesce to form coherent nanotubes comprising gold; and optionally
(a3) separating the gold nanotubes from the substrate.

21. The method of claim 20, further comprising a metal deposition step after step (a2) and before step (a3), so as to form gold nanotubes coated by said metal on the surface of said nanotubes.

22. The method of claim 21, where said metal deposition step is carried out for depositing a layer of copper.

23. The method of claim 20, wherein said metal deposition is carried out by electroless deposition or electrodeposition.

24. An electrically conductive material having a substantially hollow structure and composed of continuous, multi-layered nanoparticle arrays, said nanoparticles having a diameter of about 10 nm or higher.

25. Material having a substantially hollow structure, obtainable by a method comprising
(i) providing a substrate having pores or channels functionalized with an agent capable of binding nanoparticles, said pores or channels having a desired shape and a cross-sectional size from about several nanometers to about several hundreds of microns; and
(ii) passing through said substrate a colloid solution comprising nanoparticles and a solvent, so as to bind and form more than one layer of nanoparticles in the pores or channels, where the nanoparticles spontaneously coalesce to form a coherent material; thereby obtaining in said pores or channels a material composed of nanoparticles, said material having a substantially hollow structure that follows the shape of said pores or channels in the substrate.

26. Material according to claim 25, being metal-based material and obtainable by a method comprising: providing a substrate having pores or channels functionalized with an agent capable of binding metal nanoparticles, said pores or channels having a cross-sectional size of from several nanometers to about 100 microns; passing through said substrate a colloid solution comprising nanoparticles of one or more metal source and a solvent, so as to bind and form more than one layer of metal nanoparticles in the pores or channels, where the nanoparticles spontaneously coalesce to form coherent metallic-based material; and optionally, in the case of a porous substrate, separating the metal-based material from the porous substrate to obtain a conductive metal-based material composed of nanoparticles and having a substantially hollow structure.

27. Metal-based material according to claim 26 in the form of gold nanotubes, said gold nanotubes having a diameter of about 200 nm and comprising gold nanoparticles assembled together in the form of hollow nanotubes, where the nanoparticles diameter is between about 10 to about 20 nm.

28. A filter comprising a material obtainable by the method of claim 1.

29. An optical sensor comprising a structure formed by a material obtainable by the method of claim 1, the structure having a predetermined absorption spectrum defined by the absorption spectrum of said nanoparticles.

30. A method of separating a specific material from a solution containing said specific material, the method comprising passing said solution through the filter of claim 28.

31. A catalyst or electrocatalyst comprising nanotubes having a diameter of about 200 nm and consisting of nanoparticles assembled together in the form of hollow nanotubes, where the nanoparticle diameter is between about 10 to about 20 nm.

32. A method according to claim 1 for preparing a material composed of particles having a substantially tubular structure, the method comprising
(i) providing a substrate having nanopores functionalized with an agent capable of binding nanoparticles, said nanopores penetrating from one side of the substrate to the other side and having a diameter of about several nanometers to about 100 microns; and
(ii) passing through said substrate a colloid solution comprising nanoparticles and a solvent, so as to form more than one layer of nanoparticles in the nanopores, where the bound nanoparticles spontaneously coalesce to form a coherent tubular material.

33. The method of claim 32, further comprising the step of separating the nanotubes from the porous substrate to obtain a material having a substantially tubular structure.
